(19) United States
(12) Patent Application Publication
(10) Pub. No.: US 2022/0161076 A1
(43) Pub. Date: May 26, 2022

(54) METHOD FOR EXTINGUISHING AN ELECTROCHEMICAL GENERATOR IN THE EVENT OF A THERMAL RUNAWAY

(71) Applicant: COMMISSARIAT À L'ÉNERGIE ATOMIQUE ET AUX ÉNERGIES ALTERNATIVES, Paris (FR)

(72) Inventors: Emmanuel Billy, Grenoble (FR); David Brun-Buisson, Grenoble (FR)

(21) Appl. No.: 17/595,179

(22) PCT Filed: May 12, 2020
(86) PCT No.: PCT/EP2020/063207

§ 371 Date: Nov. 10, 2021

(30) Foreign Application Priority Data
May 15, 2019 (FR) FR1905067

(51) Int. Cl. A62C 3/06; H01M 10/613; H01M 6/50

(52) U.S. Cl. CPC A62C 3/06; H01M 2200/00; H01M 6/5038; H01M 10/613

(57) ABSTRACT

Method for extinguishing an electrochemical generator, particularly in the event of a thermal runaway, the electrochemical generator comprising a first electrode and a second electrode, the first electrode being connected to a first terminal and the second electrode being connected to a second terminal or the ground of the electrochemical generator, wherein the process comprises a step in which the electrochemical generator is covered by an ionic liquid solution, the ionic liquid solution comprising an ionic liquid and an active species with extinguishing and/or flame retardant properties. The ionic liquid solution continuously covering the electrochemical generator from the first terminal to the second terminal or from the first terminal to the ground, so as to cool and/or discharge the electrochemical generator.

### TECHNICAL DOMAIN

This invention relates to the field of safe extinguishing of an electrochemical generator, such as an Li-Ion, Na-Ion, or Lithium-metal battery or accumulator, subject to a thermal runaway.

More specifically, it is a method for putting an electrochemical generator in a safe state in which the electrochemical generator is cooled and/or discharged with a solution containing an ionic liquid.

Putting in a safe state may be done by automatic extinguishing of the electrochemical generator by flooding in a stationary application.

Putting in a safe state may also be done by means of a mobile device such as an extinguisher, for example during an intervention by a fireman.

### State of Prior Art

An electrochemical generator is an electricity generation device that converts chemical energy into electrical energy. For example, it could be batteries or accumulators.

The market for accumulators, and in particular lithium accumulators of the type Li-ion, is expanding strongly at the present time, firstly due to so-called mobile applications (smartphone, portable electric tools, etc.) and secondly due to new applications linked to mobility (electric and hybrid vehicles) and so-called stationary applications (connected to the electricity network).

An Li-ion type lithium electrochemical accumulator comprises at least one electrochemical cell comprising an anode (negative electrode) and a cathode (positive electrode) located on each side of a separator impregnated with an electrolyte, and current collectors.

Metal-ion electrochemical accumulators operate according to the principle of insertion or removal (or, in other words, intercalation-deintercalation) of metal ions in at least one electrode. During charging, the lithium is deintercalated from the active material of the cathode and the active material of the anode, for example graphite, is inserted. The process is reversed during discharge.

When an accumulator is placed under unusual conditions such as exposure to extreme temperature, electrical use outside the manufacturer's specification, or even degradation of the physical integrity, chemical degradation reactions and/or an internal electrical short circuit may occur. These phenomena can lead to a release of intense internal heat, generation of gas or fire or even pneumatic expansion.

Chemical mechanisms are initiated when materials are subjected to a temperature higher than the reaction activation temperature. Typically, in the case of the reaction between the graphite passivation layer (SEI or “Solid Electrolyte Interface”) and the electrolyte, the initiation temperature of the degradation mechanism is approximately 80° C.

The release of generated internal heat may activate other exothermic phenomena such as the reaction of the cathode material with the electrolyte (about 160 to 200° C.), or the generation of an internal short circuit (melting of the separator between about 120 and 160° C.). Each of these heating mechanisms may be the precursor to activation of other mechanisms. The term runaway is then used.

To limit or stop thermal runaway and prevent the occurrence of undesirable phenomena, the temperature rise has to be limited by efficient cooling of the accumulator and/or by a decrease in the amount of electrical energy contained in the accumulator (discharge). Heating induced by the internal short circuit and degradation reactions tend to disappear when the accumulator is discharged.

Traditionally, a sprinkling step or even a flooding step using a water-based extinguishing agent can be used to stop thermal runaway of the accumulator. Water offers two advantages:

good cooling quality and discharge of electrical energy when the aqueous environment is conductive and continuous between the potentials of the accumulator.

However, this extinguishing means has the disadvantage that hydrogen gas that can ignite is produced. Moreover, if the integrity of the accumulator is not preserved, the active materials will react violently with water, thus producing large quantities of heat and hydrogen gas.

This problem is currently a major issue because manufacturers are continuously aiming to increase the energy of their accumulators and therefore they are using increasingly exothermic materials.

### PRESENTATION OF THE INVENTION

One purpose of this invention is to propose a method for overcoming the disadvantages of prior art, and in particular an extinguishing method to put an electrochemical generator into a safe state, by providing good cooling and/or discharging the generator, without producing any hydrogen.

To achieve this, this invention discloses a method for extinguishing an electrochemical generator, particularly in the event of a thermal runaway, the electrochemical generator comprising a first electrode and a second electrode, the first electrode being connected to a first terminal and the second electrode being connected to a second terminal or the ground of the electrochemical generator,

the method comprising a step in which the electrochemical generator is covered by an ionic liquid solution,

the ionic liquid solution continuously covering the electrochemical generator from the first terminal to the second terminal or from the first terminal to the ground,

the ionic liquid solution comprising an ionic liquid and an active species with extinguishing and/or flame retardant properties.

Thermal runaway means the activation of exothermic degradation reactions within the generator, that leads to an increase in the internal temperature and that activates a cascade of undesirable chemical reactions.

The invention is fundamentally different from prior art in that the electrochemical generator is extinguished by an ionic liquid solution.

The method prevents the generation of oxygen and hydrogen, and therefore there are no risks of inflammation or explosion, unlike a method using an aqueous solution.

The use of an ionic liquid solution significantly reduces constraints associated with the use of water because ionic liquids are non-volatile, non-flammable and chemically stable at temperatures that may exceed 200° C. (for example, between 200° C. and 400° C.).

The electrochemical generator may be intact or damaged.

If the packaging breaks, the ionic liquid medium prevents contact between air and the internal components of the electrochemical generator and therefore the formation of a mixture between air and electrolyte vapours (air/vapour fraction) that is particularly explosive.

The method cools the accumulator.

It is simple to implement.

Advantageously, the active species is an alkyl phosphate, possibly fluorinated.

Advantageously, the active species represents 5 to 80% by mass of the ionic liquid solution, and preferably 10 to 30% by mass.

Advantageously, the ionic liquid solution comprises a redox species that can be oxidized and/or reduced on at least one of the first terminal and the second terminal or on at least one of the first terminal and the ground. Advantageously, the presence of a redox species makes it possible to discharge the generator without degradation/transformation of the ionic liquid solvent.

If the electrochemical generator is opened, the ionic liquid solvent and/or redox species can react with the active electrode material such as lithium or sodium, which makes it possible to put the generator in a safe state by discharging it.

Advantageously, the solution comprises a couple of redox species comprising a redox species called an oxidant and a redox species called a reductant, the oxidant redox species possibly being reduced on either the first or the second terminal (or the ground) and the reductant redox species possibly being oxidized on the other second or first terminal (or the ground).

A redox couple, also called redox mediator or electrochemical shuttle, means an oxidizing/reducing (Ox/Red) couple in solution for which the oxidant can be reduced and the reductant can be oxidized on the terminals or on a terminal or the ground of the electrochemical generator. The redox couple controls redox reactions.

The redox species make(s) it possible to significantly or totally discharge the electrochemical generator, by reducing the potential difference between the electrodes (anode and cathode). This discharge also contributes to putting the electrochemical generator into a safe state by reducing the chemical energy of the electrodes (and therefore the potential difference) and by reducing the effect of an internal short circuit. The electrochemical generator is made safe even in the case of structural deterioration because the redox species can react directly on the electrodes.

The method is economical because the redox couple in solution controls redox reactions simultaneously at the terminals of the electrochemical generator, such that the consumption of reagent is zero; the solution can be used to put several electrochemical generators into a safe state successively and/or in mixture.

Advantageously, the redox species couple is a metallic couple, preferably chosen from among Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, an organic molecules couple, a metallocenes couple such as Fc/Fc⁺, or a halogenated molecules couple such as for example Cl₂/Cl⁻ or Cl/Cl³⁻.

Advantageously, the ionic liquid solution comprises a drying agent.

Advantageously, the ionic liquid solution comprises an agent promoting material transport, such as an organic solvent.

Advantageously, the ionic liquid solution comprises a protective agent that can reduce and/or stabilise corrosive and/or toxic elements. This reduces the acid impact of toxic and corrosive species such as PF₅, HF, POF₃, etc.

Advantageously, the ionic liquid solution comprises an additional ionic liquid.

Advantageously, the ionic liquid solution forms a deep eutectic solvent.

According to a first advantageous variant, the electrochemical generator is immersed in the ionic liquid solution.

According to another advantageous variant, the electrochemical generator is sprayed with the ionic liquid solution, for example by means of an extinguisher containing the ionic liquid solution.

This invention also relates to a fire-fighting device such as an extinguisher, comprising a tank containing product to be sprayed and a pressurised gas capsule, the product to be sprayed being an ionic liquid solution comprising an ionic liquid solvent and an active species having extinguishing and/or flame-retardant properties.

The product to be sprayed (or extinguishing agent) does not produce hydrogen, has a calorific capacity of 1.2 to 2.2 J g⁻¹K⁻¹, and a thermal conductivity of approximately 0.2 W m⁻¹K⁻¹. It enables effective extinguishing of electrochemical generators in complete safety.

Other characteristics and advantages of the invention will become clear after reading the remaining description given below.

It should be understood that the remaining description is only given to illustrate the purpose of the invention and can in no way be interpreted as a limitation of this purpose.

### BRIEF DESCRIPTION OF THE DRAWINGS

This invention will be better understood after reading the description of example embodiments given purely for information and that is in no way limitative, with reference to the appended drawings on which:

FIG. 1 diagrammatically shows a sectional view of an electrochemical generator, according to one particular embodiment of the invention,

FIG. 2 diagrammatically shows a step in the method of extinguishing an electrochemical generator, according to one particular embodiment of the invention,

FIG. 3 diagrammatically shows a step in the method of extinguishing an electrochemical generator, according to another particular embodiment of the invention,

FIG. 4 is an intensity-potential curve representing different redox potentials according to one particular embodiment of the invention.

The different parts represented on the figures are not necessarily all at the same scale, to make the figures more easily understandable.

The different possibilities (variants and embodiments) must be understood as not being mutually exclusive and can be combined with each other.

### DETAILED PRESENTATION OF PARTICULAR EMBODIMENTS

Even if the description given below refers to an Li-ion accumulator, the invention can be transposed to any electrochemical generator, for example to a battery comprising several accumulators (also called accumulator batteries), connected in series or in parallel, depending on the nominal operating voltage and/or the amount of energy to be supplied, or to a battery cell.

These different electrochemical devices can be of the metal-ion type, for example lithium-ion or sodium-ion, or of the Li-metal type, etc.

It may also be a primary system such as Li/MnO₂, or a Redox Flow Battery.

We will advantageously choose an electrochemical generator with a potential greater than 1.5V.

In the following, when lithium is described, the lithium can be replaced by sodium.

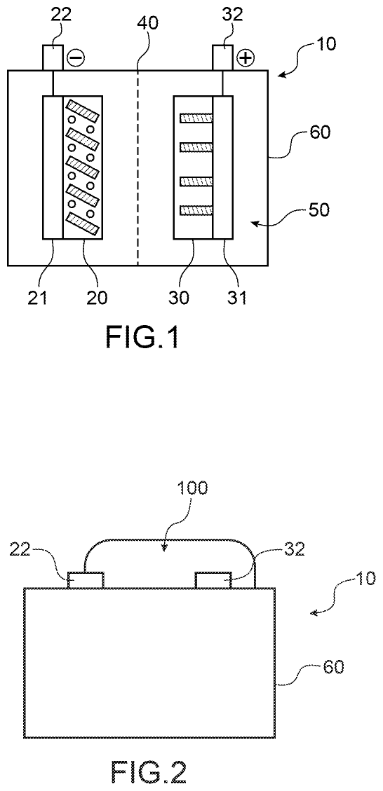

The description refers firstly to FIG. 1, that represents a lithium-ion (or Li-ion) accumulator 10. A single electrochemical cell is shown but the generator can consist of several electrochemical cells, each cell comprising a first electrode 20, in this case the anode, and a second electrode 30, in this case the cathode, a separator 40 and an electrolyte 50. In another embodiment, the first electrode 20 and the second electrode 30 could be reversed.

The anode (negative electrode) 20 is preferably carbon-based, for example made of graphite that can be mixed with a PVDF-type binder and deposited on a copper sheet. It may also be a mixed oxide of lithium such as lithium titanate Li₄Ti₅O₁₂ (LTO) for an Li-ion accumulator or a mixed oxide of sodium such as sodium titanate for an Na-ion accumulator. It could also be a lithium alloy or a sodium alloy depending on the technology chosen.

The cathode (positive electrode) 30 is a lithium ion insertion material for an Li-ion accumulator. It may be a lamellar oxide of the LiMO₂ type, a phosphate LiMPO₄ with an olivine structure or a spinel compound LiMn₂O₄. M represents a transition metal. For example, a positive electrode made of LiCoO₂, LiMnO₂, LiNiO₂, Li₃NiMnCoO₆, or LiFePO₄ will be chosen.

The cathode (positive electrode) 30 is a sodium ion insertion material for an Na-ion accumulator. It may be a material of the mixed oxide of sodium type comprising at least one transition metal element, a material of the phosphate or mixed sulphate of sodium type comprising at least one transition metal element, a material of the mixed fluoride of sodium type, or a sulphide type material comprising at least one transition metal element.

The insertion material may be mixed with a polyvinylidene fluoride type binder and deposited on an aluminium foil.

The electrolyte 50 contains lithium salts (for example LiPF₆, LiBF₄, LiClO₄ or sodium salts (for example N₃Na), depending on the selected accumulator technology, solubilised in a mixture of non-aqueous solvents. For example, the solvent mixture may be a binary or ternary mixture. For example, the solvents may be selected from among solvents based on cyclic carbonates (ethylene carbonate, propylene carbonate, carbonate butylene), linear or branched carbonates (dimethyl carbonate, diethyl carbonate, ethyl methyl carbonate, dimethoxyethane) in varying proportions.

Alternatively, it could also be a polymer electrolyte comprising a polymer matrix, made of an organic and/or inorganic material, a liquid mixture comprising one or more metal salts, and possibly a mechanical reinforcing material. The polymer matrix may comprise one or more polymer materials, for example, chosen from among a polyvinylidene fluoride (PVDF), a polyacrylonitrile (PAN), a polyvinylidene fluoride hexafluoropropylene (PVDF-HFP), or a poly(ionic liquid) of the poly(N-vinylimidazolium) bis(trifluoromethanesulfonylamide)), N, N-diethyl-N-(2-methoxyethyl)-N-methylammonium bis(trifluoromethylsulfonyl)imide type (DEMM-TFSI)).

The cell may be wound on itself around a winding axis, or it may have a stacked architecture.

A casing 60, for example a polymer bag or a metal packaging, for example steel, is used to seal the accumulator.

Each electrode 20, 30 is connected to a current collector 21, 31 passing through the casing 60 and forming terminals 22, 32 respectively, outside the casing 60, (also called output terminals or electrical poles or terminals). The collectors 21, 31 perform two functions: to provide mechanical support for the active material and conduction of electricity to the cell terminals. The terminals are also called electrical poles or terminals, and form the output terminals and are intended to be connected to an “energy receiver”.

In some configurations, one of the terminals 22, 32 (for example the one connected to the negative electrode) can be connected to the ground of the electrochemical generator. It is then said that the ground is the negative potential of the electrochemical generator and that the positive terminal is the positive potential of the electrochemical generator. Therefore the positive potential is defined as the positive pole/terminal and all metal parts connected by electrical continuity from this pole.

An intermediate electronic device may possibly be placed between the terminal that is connected to the ground, and the ground.

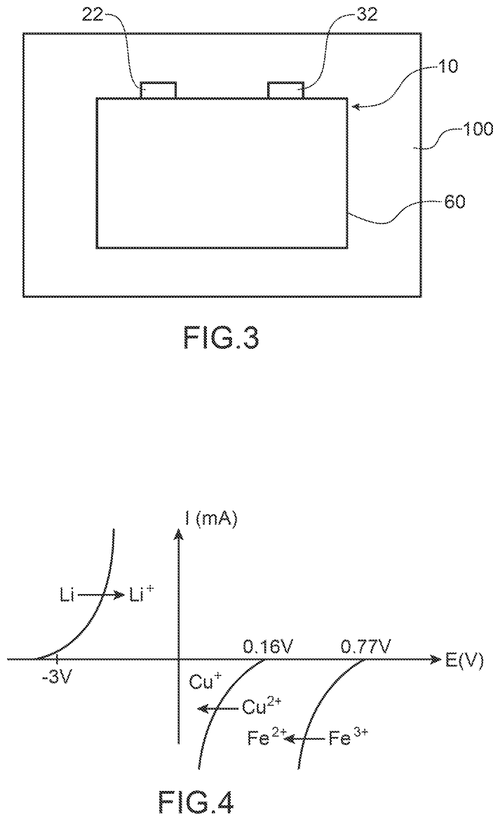

As shown in FIGS. 2 and 3, the extinguishing method comprises a step in which the accumulator 10 is at least partly covered by a so-called extinguishing solution, to put such a accumulator 10 into a safe state.

At least partially covering it means that the accumulator 10 can be:

partially covered by the solution (FIG. 2), for example by spraying by any suitable means, for example with an extinguisher, particularly during the intervention of a fireman or any other person; or

fully covered by the solution (FIG. 3), for example by immersion, for example during automatic extinguishing, by flooding, especially for stationary applications.

The extinguishing solution 100 is an ionic liquid solution (also called a solution of ionic liquid), in other words it comprises at least one ionic liquid denoted LI₁, called the ionic liquid solvent, and an active species denoted A1 that is an extinguishing agent and/or flame retardant to prevent thermal runaway.

Ionic fluid refers to the association comprising at least one cation and an anion that generates a liquid with a melting temperature less than or close to 100° C. These are molten salts.

An ionic liquid solvent is an ionic liquid that is thermally and electrochemically stable, minimising an effect of environmental degradation during the discharge phenomenon.

The ionic liquid solution may also comprise one or more (for example, two or three) additional ionic liquids, in other words it comprises a mixture of several ionic liquids.

An additional ionic liquid denoted LI₂ refers to an ionic liquid that improves one or more properties useful for the safety and discharge step. In particular, this may relate to one or more of the following properties: extinguishing, flame retardant, redox shuttle, salt stabiliser, viscosity, solubility, hydrophobicity, conductivity.

Advantageously, the ionic liquid, and possibly the additional ionic liquids, are liquid at room temperature (from 20 to 25° C.).

For the ionic liquid solvent and for the additional ionic liquid(s), the cation is preferably chosen from the family:

imidazolium, pyrrolidinium, ammonium, piperidinium and phosphonium.

Preferably, a cation with a wide cationic window will be chosen, sufficiently wide to envisage a cathodic reaction that avoids or minimises degradation of the ionic liquid.

Advantageously LI₁ and LI₂ will have the same cation to increase the solubility of LI₂ in LI₁. In the many possible systems, a low-cost, non-toxic medium with low environmental impact (biodegradability) will be preferred.

Advantageously, anions that can simultaneously obtain a wide electrochemical window, moderate viscosity, a low melting temperature (liquid at room temperature) and good solubility with the ionic liquid and other species of the solution will be used, without leading to hydrolysis (degradation) of the ionic liquid.

The TFSI anion is one example that satisfies the criteria mentioned above for many associations, for example with LI₁:

[BMIM][TFSI], or the use of an ionic liquid of the [P66614][TFSI] type, the 1-ethyl-2,3-trimethyleneimidazolium bis(trifluoromethane sulfonyl)imide ([ETMIm][TFSI]) ionic liquid, the N,N-diethyl-N-methyl-N-2-methoxyethyl ammonium bis(trifluoromethylsulfonyl)amide [DEME][TFSA] ionic liquid, the N-Methyl-N-butylpyrrolidinium bis(trifluoromethylsulfonyl)imide ([PYR14][TFSI]) ionic liquid, the N-methyl-N-propylpiperidinium bis(trifluoromethanesulfonyl) imide (PP13-TFSI) ionic liquid. The anion may also be of the bis(fluorosulfonyl)imide (FSA or FSI) type, such as the N-methyl-N-propylpyrrolidinium FSI (P13-FSI) ionic liquid, N-methyl-N-propylpiperidinium FSI (PP13-FSI), 1-ethyl-3-methylimidalium, FSI, etc.

The anion of the ionic liquid solvent LI₁ and/or the additional liquid LI₂ may be a complexing anion to form a complex with the electrochemical shuttle.

Other associations can be envisaged, with ionic liquids in which the cation will be associated with an anion that will indifferently be organic or inorganic, preferably having a wide anodic window.

The ionic liquid solution advantageously forms a deep eutectic solvent (DES). It is a liquid mixture at room temperature obtained by forming an eutectic mixture of 2 salts, with general formula:

[Cat]⁺·[X]⁻·z[Y]

in which

[Cat]⁺ is the cation of the ionic liquid solvent (e.g. ammonium),

[X]⁻ is the halide anion (for example Cl⁻),

[Y] is a Lewis or Brönsted acid that can be complexed by the X⁻ anion of the ionic liquid solvent, and

z is the number of molecules Y.

Eutectics can be divided into three categories depending on the nature of Y.

The first category corresponds to a type I eutectic:

Y=MClₓ for example with M=Fe, Zn, Sn, Fe, Al, Ga

The first category corresponds to a type II eutectic:

Y=MClₓ.YH₂O for example with M=Cr, Co, Cu, Ni, Fe

The first category corresponds to a type III eutectic:

Y=RZ for example with Z=CONH₂, COOH, OH.

For example, the DES is choline chloride in combination with an H-bond donor with very low toxicity, such as glycerol or urea, guaranteeing a non-toxic and very low cost DES.

According to another example embodiment, choline chloride can be replaced by betaine. Even if these systems have a limited electrochemical stability window, they help to guarantee flooding and deactivation of a potentially open accumulator.

Advantageously, a compound “Y” that can act as an electrochemical shuttle that can be oxidized and/or reduced will be chosen. For example, Y is a metal salt that can be dissolved in the ionic liquid solution to form metal ions. For example, Y contains iron.

As an illustration, a eutectic can be formed between an ionic liquid with a chloride anion and metallic salts FeCl₂ and FeCl₃ for different proportions and with different cations.

This type of reaction can also be produced with type II eutectics that integrate into the metal salts of water molecules, this does not create any danger when the proportion of water is low. Low means typically less than 10% by mass of the solution, for example 5 to 10% by mass of the solution.

Type III eutectics that associate the ionic liquid with hydrogen bond donor species (Y) can also be used, with an [LI₁]/[Y] type mixture in which LI₁ may be a quaternary ammonium and Y may be a complexing molecule (hydrogen bond donor) such as urea, ethylene glycol, thiourea, etc . . . .

A mixture can also be made that will advantageously modify the properties of the solution for discharging the medium. In particular, it is possible to associate an ionic liquid solvent of the [BMIM] [NTF₂] type that is very stable and liquid at room temperature, but weakly solubilises the electrochemical shuttle (or redox mediator), such as iron chloride.

The additional ionic liquid LI₂ may be of the [BRIM][Cl] type, the anion [Cl] will promote solubilisation of a metallic salt (MClₓ) by complexation. This makes it possible to have good transport properties and a good solubility of the redox mediator simultaneously, and therefore to promote the discharge phenomenon.

The active species denoted A1 is an extinguishing agent and/or flame retardant intended to prevent thermal runaway, especially in the case of an accumulator being opened. It may be an alkyl phosphate, possibly fluorinated (fluorinated alkyl phosphate), such as trimethyl phosphate, triethyl phosphate, or tris(2,2,2-trifluoroethyl) phosphate. The concentration of the active species can vary from 80% to 5% by mass, preferably from 30% to 10% by mass.

Preferably, the solution also comprises a redox species denoted A2 that can be oxidised and/or reduced on at least one of the terminals or at least on the ground. The redox species makes it possible to put the accumulator in a safe state.

Preferably, it is a redox couple acting as an electrochemical shuttle (or redox mediator) to reduce degradation of the medium by performing redox reactions.

A redox couple means an oxidant and a reductant in solution that can be reduced and oxidized respectively on the terminals of the cells. The oxidant and the reductant may be introduced in equimolar or non-equimolar proportions.

If the electrochemical generator is opened, one of the redox species may originate from the generator itself. This may include cobalt, nickel and/or manganese in particular.

The redox couple can be a metal electrochemical couple or one of their associations:

Mn²⁺/Mn³⁺, Co²⁺/Co³⁺, Cr²⁺/Cr³⁺, Cr³⁺/Cr⁶⁺, V²⁻/V³⁺, V⁴⁺/V⁵⁺, Sn²⁺/Sn⁴⁺, Ag⁻/Ag²⁺, Cu⁻/Cu²⁺, Ru⁴⁺/Ru⁸⁺ or Fe²⁺/Fe³⁺.

The redox species and the redox couple can also be selected from among organic molecules, and in particular from: 2,4,6-tri-t-butylphenoxyl, nitronyl nitroxide/2,2,6,6-tetra methyl-1-piperidinyloxy (TEMPO), tetracyanoethylene, tetra methyl phenylenediamine, dihydrophenazine, aromatic modules such as methoxy, the N,N-dimethylamino group (anisole methoxybenzene, dimethoxybenzene, and N,N-dimethylaniline N,N-dimethylaminobenzene). Other examples include 10-methyl-phenothiazine (MPT), 2,5-di-tert-butyl-1,4-dimethoxybenzene (DDB), and 2-(pentafluorophenyl)-1,3,2-tetrafluorodioxaborole (PFPTFBDB).

It may also be the metallocenes family (Fc/Fc+, Fe(bpy)₃(ClO₄)₂ and Fe(phen) 3(ClO₄)₂ and its derivatives) or the halogenated molecules family (Cl₂/Cl⁻, Cl⁻/Cl³⁻ Br₂/Br⁻, I₂/I⁻, I⁻/I₃⁻).

A bromide or chloride will be chosen in particular. Preferably it is a chloride, that can easily complex metals. For example, iron, complexed by the chloride anion, forms FeCl₄⁻ that can decrease the reactivity of the negative electrode.

It may also be tetramethylphenylenediamine.

Several redox couples may also be associated, in which the metals of metal ions are identical or different.

For example, Fe²⁺/Fe³⁺ and/or Cu⁺/Cu²⁺ will be chosen. The latter are soluble in their two oxidation states, they are not toxic, they do not degrade the ionic liquid and they have suitable redox potentials to extract lithium (FIG. 4).

Optionally, the ionic liquid solution may comprise a drying agent denoted A3, and/or an agent promoting material transport A4, and/or a protective agent that is a stabiliser/reducer of corrosive and toxic species A5 such as PF₅, HF, POF₃ etc.

For example, the agent promoting material transport denoted A4 is a fraction of a co-solvent that can be added to reduce viscosity.

It can be a small proportion of water, such as 5% of water.

Preferably, an organic solvent will be chosen to act effectively without generating discharge or flammability risks. It may be vinylene carbonate (VC), gamma-butyrolactone (γ-BL), propylene carbonate (PC), poly(ethylene glycol), dimethyl ether. Advantageously, the concentration of the agent promoting material transport ranges from 1% to 40% and more advantageously from 10% to 40% by mass.

The protective agent capable of reducing and/or stabilising corrosive and/or toxic elements A5 is, for example, a butylamine-type compound, a carbodiimide (type N,N-dicyclohexylcarbodiimide), N,N-diethylamino trimethyl-silane, tris(2,2,2-trifluoroethyl) phosphite (TTFP), an amine-based compound such as 1-methyl-2-pyrrolidinone, a fluorinated carbamate or hexamethyl-phosphoramide. It may also be a compound in the cyclophosphazenes family such as hexamethoxycyclotriphosphazene

Advantageously, the ionic liquid solution contains less than 10% of water by mass, preferably less than 5% by mass.

Even more preferably, the ionic liquid solution contains no water.

The method can be used at temperatures ranging from 0° C. to 100° C., preferably from 20° C. to 60° C. and even more preferentially it is implemented at ambient temperature (20-25° C.).

The method can be used under air, or under an inert atmosphere, for example under argon or under nitrogen.

In the case in which the electrochemical generator is immersed in the extinguishing solution, the solution may be stirred to improve the reagent supply. For example, stirring may be done at between 50 and 2000 rpm, and preferably between 200 and 800 rpm.

### Illustrative and Non-Limitative Examples of One Embodiment

### Example 1: Discharge in Choline Chloride Urea FeCl₃ Medium

The ionic liquid solution is a mixture of choline chloride and urea, with a molar ratio of 1 to 2, to which 0.3M of FeCl₃ was added. After the solution has dried, an Li-ion type cell 18650 is put into contact with 50 ml of this solution, at ambient temperature while stirring at 800 rpm. After 96 hours, the battery is taken out of the bath and the cell voltage is equal to zero, indicating that the system is discharged.

Immersion (flooding) of the Li-ion accumulator in a ionic liquid solution containing an extinguishing agent allows a total discharge of the accumulator, thus making it Electrically Safe.

### Example 2: Putting an Li-Ion Accumulator Module into a Safe State During Action by Fireman

An accumulator module, comprising Li-ion accumulators with a capacity of 20 Ah and a voltage of 50V, i.e. an electrical energy of 1 kWh. The volume of this module is 8 L and its weight is 12 kg. The calorific capacity of the accumulator module is estimated at 0.9 J·kg⁻¹. When this module fails, the thermal energy generated by the exothermic reactions and combustion is 12000 kJ (reference value: 1000 kJ/kg of Li-ion accumulator).

In order to put the defective module into a safe state, the module is flooded with an extinguishing ionic liquid solution containing ethaline (mixture of choline chloride: ethylene glycol in mass ratio 1:2) with a Cp of 2.2 J·g⁻¹·K⁻¹ and 5% by mass trimethyl phosphate. The module is flooded with a mass of extinguishing agent of 120 kg, i.e. a volume of 107 L. Regarding the mass of the module and the mass of the extinguishing agent, the total calorific capacity of the thermodynamic system is approximately 275 kJ·K⁻¹ (corresponding to 120000 g×2.2 J·g⁻¹K⁻¹+12000 g×0.9 J·kg⁻¹·K⁻¹). Assuming an initial temperature of 20° C. for the extinguishing agent and for the accumulator module, the temperature of the complete system will not exceed 64° C. in the case of a total feared event of the module (20° C.+12000 kJ/275 kJ·K⁻¹). This temperature is sufficiently low to ensure that the properties of the extinguishing agent are maintained, and to put the module in a safe state.

In addition, the capacity of the extinguishing agent to discharge the accumulator will reduce the combustion energy of the accumulators module by a factor of 2 when an accumulator is fully discharged. At the same time, this cumulative effect can also reduce the maximum temperature reached.

What is claimed is:

1.-14. (canceled)

15. A method for extinguishing an electrochemical generator,
particularly in the event of a thermal runaway, the electrochemical generator comprising a first electrode and a second electrode, the first electrode being connected to a first terminal and the second electrode being connected to a second terminal or the ground of the electrochemical generator,
wherein the process comprises a step in which the electrochemical generator is covered by an ionic liquid solution,
the ionic liquid solution comprising an ionic liquid and an active species with extinguishing or flame retardant properties.
the ionic liquid solution continuously covering the electrochemical generator from the first terminal to the second terminal or from the first terminal to the ground, so as to cool or discharge the electrochemical generator.

16. The method according to claim 15, wherein the active species is an alkyl phosphate.

17. The method according to claim 15, wherein the active species is a fluorinated alkyl phosphate.

18. The method according to claim 15, wherein the active species represents 5 to 80% by mass of the ionic liquid solution.

19. The method according to claim 18, wherein the active species represents 10 to 30% by mass of the ionic liquid solution.

20. The method according to claim 15, wherein the ionic liquid solution comprises a redox species that can be oxidized or reduced.

21. The method according to claim 15, wherein the ionic liquid solution comprises a couple of redox species comprising a redox species called an oxidant and a redox species called a reductant, the oxidant redox species possibly being reduced and the reductant redox species possibly being oxidized.

22. The method according to claim 21, wherein the redox species couple is a metallic couple, an organic molecules couple, a metallocenes couple or a halogenated molecules couple.

23. The method according to claim 22, wherein the metallic couple is a metallic couple selected from the group consisting of Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺.

24. The method according to claim 15, wherein the ionic liquid solution comprises a drying agent.

25. The method according to claim 15, wherein the ionic liquid solution comprises an agent promoting material transport.

26. The method according to claim 15, wherein the ionic liquid solution comprises a protective agent that can reduce or stabilise corrosive or toxic elements.

27. The method according to claim 15, wherein the ionic liquid solution comprises an additional ionic liquid.

28. The method according to claim 15, wherein the ionic liquid solution forms a deep eutectic solvent.

29. The method according to claim 15, wherein the electrochemical generator is immersed in the ionic liquid solution.

30. The method according to claim 15, wherein the electrochemical generator is sprayed with the ionic liquid solution.

31. A fire-fighting device comprising a tank containing product to be sprayed and a pressurised gas capsule, the product to be sprayed being an ionic liquid solution comprising an ionic liquid solvent and an active species having extinguishing or flame-retardant properties for use of the method of extinguishing an electrochemical generator according to claim 15.

32. The fire-fighting device according to claim 31, wherein the fire-fighting device is a fire extinguisher.
